(19) United States
(12) Patent Application Publication
(10) Pub. No.: US 2010/0265616 A1
(43) Pub. Date: Oct. 21, 2010

(54) MAGNETIC RECORDING HEAD AND MAGNETIC STORAGE DEVICE

(75) Inventors: Masaya Ohtake, Tokyo (JP); Ryoji Ito, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/761,109

(22) Filed: Apr. 15, 2010

(30) Foreign Application Priority Data
Apr. 20, 2009 (JP) 2009-102232

(51) Int. Cl. G11B 5/127

(52) U.S. Cl. 360/110; G9B/5.04

(57) ABSTRACT

According to one embodiment, a magnetic recording head includes a flying surface and an exposed surface exposed on the flying surface. The exposed surface is defined by oblique sides and a lower side of a trapezoid having an upper side on the trailing side, and a contour line. The lower side on the leading side extends in parallel to the upper side and is shorter than the upper side. The contour line extends from one end to the other end of the upper side and rises from the upper side towards the trailing side between extended lines of the oblique sides.

### CROSS-REFERENCE TO RELATED APPLICATIONS

This application is based upon and claims the benefit of priority from Japanese Patent Application No. 2009-102232, filed Apr. 20, 2009, the entire contents of which are incorporated herein by reference.

### BACKGROUND

1. Field

One embodiment of the invention relates to a magnetic recording head.

2. Description of the Related Art

For example, a hard disk drive (HDD) is widely known. In the HDD, a magnetic disk is incorporated. A magnetic recording head faces the magnetic disk. In the magnetic recording head, an exposed surface is defined on the flying surface of the head slider by a trapezoid having an upper side on the trailing side and a lower side, which extends parallel to the upper side and is shorter than the upper side, on the leading side. Reference may be had to, for example, Japanese Patent Application Publication (KOKAI) No. 2008-204526 and Japanese Patent Application Publication (KOKAI) No. 2006-134507.

A bit-patterned medium is widely known. In a certain type of bit-patterned medium, recording tracks are formed in a staggered magnetic dot pattern. Upon writing magnetic information, the magnetic recording head magnetizes magnetic dots on right and left lines alternately. At this time, on the innermost recording track and the outermost recording track, the trapezoidal exposed surface of the magnetic recording head largely inclines with respect to the recording tracks due to a yaw angle. For example, in the magnetic recording head, when the upper side largely inclines toward the outer periphery of the bit-patterned medium comparing to the lower side, the distance decreases in the direction of the recording track lines from passing through a magnetic dot on the left line to passing through a magnetic dot on the right line. In other words, a write margin decreases. The decrease of the write margin inhibits accurate write operation.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view schematically illustrating a structure of a hard disk drive (HDD) as one specific example of a magnetic storage device according to an embodiment of the invention;

FIG. 2 is an exemplary partial plan view of a magnetic disk in the embodiment;

FIG. 3 is an exemplary partial enlarged plan view of the magnetic disk in the embodiment;

FIG. 4 is an exemplary partial enlarged cross-sectional view taken along the line 4-4 of FIG. 3 in the embodiment;

FIG. 5 is an exemplary enlarged perspective view schematically illustrating a flying head slider in the embodiment;

FIG. 6 is an exemplary front view of an electromagnetic transducer device schematically illustrating the electromagnetic transducer device as viewed from a medium facing surface in the embodiment;

FIG. 7 is an exemplary cross-sectional view taken along the line 7-7 of FIG. 6 in the embodiment;

FIG. 8 is an exemplary enlarged partial perspective view schematically illustrating an end of a main magnetic pole in the embodiment;

FIGS. 9A and 9B are exemplary views schematically illustrating a relationship between an end surface of the main magnetic pole and a recording track in the embodiment;

FIGS. 10A and 10B are exemplary views schematically illustrating a relationship between an end surface of an inverted trapezoidal shape and a recording track in the embodiment;

FIG. 11 is an exemplary enlarged perspective view of a main magnetic pole layer schematically illustrating a shape of the main magnetic pole layer during the process of forming the main magnetic pole in the embodiment;

FIGS. 12A to 12D are exemplary enlarged front views schematically illustrating the process of forming a magnetic end piece in the embodiment; and

FIGS. 13A to 13C are exemplary enlarged front views of an end surface of another shape in the embodiment.

### DETAILED DESCRIPTION

Various embodiments according to the invention will be described hereinafter with reference to the accompanying drawings. In general, according to one embodiment of the invention, a magnetic recording head comprises a flying surface and an exposed surface exposed on the flying surface. The exposed surface is defined by oblique sides and a lower side of a trapezoid having an upper side on the trailing side, and a contour line. The lower side on the leading side extends in parallel to the upper side and is shorter than the upper side. The contour line extends from one end to the other end of the upper side and rises from the upper side towards the trailing side between extended lines of the oblique sides.

According to another embodiment of the invention, a magnetic storage device comprises a housing, a magnetic storage medium, and a magnetic recording head. The magnetic storage medium is housed in the housing and comprises recording tracks formed in a staggered magnetic dot pattern. The magnetic recording head is configured to face the magnetic storage medium. The magnetic recording head comprises a flying surface and an exposed surface exposed on the flying surface. The exposed surface is defined by oblique sides and a lower side of a trapezoid having an upper side on the trailing side, and a contour line. The lower side on the leading side extends in parallel to the upper side and is shorter than the upper side. The contour line extends from one end to the other end of the upper side and rises from the upper side towards the trailing side between extended lines of the oblique sides.

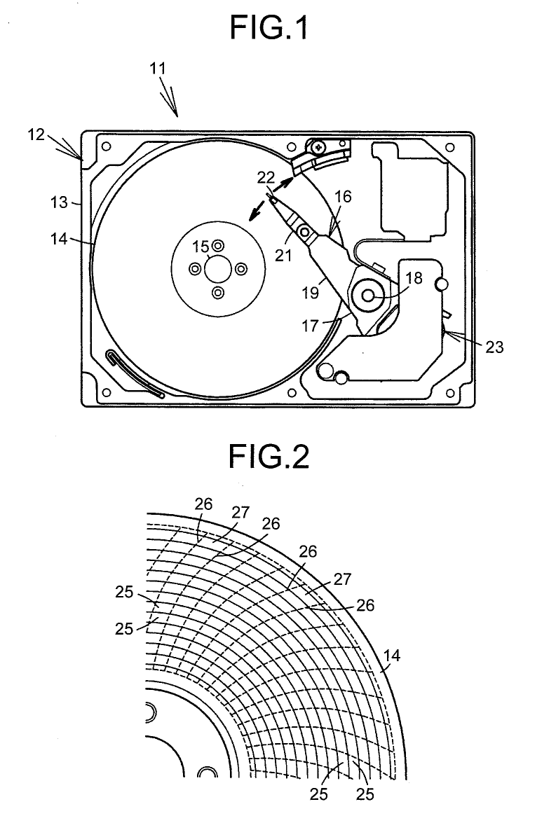

FIG. 1 schematically illustrates a structure of a hard disk drive (HDD) 11 as one specific example of a magnetic storage device according to an embodiment of the invention. The HDD 11 comprises a housing 12. The housing 12 comprises a box-shaped base 13 and a cover (not illustrated). The base 13 defines, for example, a flat rectangular parallelepiped internal space, or a housing space. The cover is connected to an opening of the base 13. The housing space is sealed between the cover and the base 13.

In the housing space, at least one magnetic disk 14, one specific example of a storage medium, is housed. The magnetic disk 14 is mounted on a drive shaft of a spindle motor 15. The spindle motor 15 can rotate the magnetic disk 14 at high speed, such as 5400 rpm, 7200 rpm, 10000 rpm, or 15000 rpm.

In the housing space, a carriage 16 is also housed. The carriage 16 comprises a carriage block 17, which is rotatably connected to a spindle 18 extending in the vertical direction from a bottom plate of the base 13. In the carriage block 17, a plurality of carriage arms 19 are defined extending horizontally from the spindle 18.

The carriage 16 comprises a plurality of head suspensions 21. Each of the head suspensions 21 is attached to the end of corresponding one of the carriage arms 19. The head suspension 21 extends frontward from the end of the carriage arm 19. The head suspension 21 has a flexure attached thereto. On the flexure, a flying head slider 22 is supported. The flying head slider 22 can change the attitude or posture relative to the head suspension 21 based in the flexure. On the flying head slider 22, an electromagnetic transducer device (not illustrated) is mounted as the head device. The electromagnetic transducer device will be described in detail later.

When an air flow is generated on the surface of the magnetic disk 14 by rotation of the magnetic disk 14, positive pressure, i.e., buoyancy, and negative pressure act on the flying head slider 22 by the action of the air flow. The buoyancy is in balance with the negative pressure and a pressing force of the head suspension 21. As a result, the flying head slider 22 can keep floating relatively firmly during the rotation of the magnetic disk 14.

To the carriage block 17, a voice coil motor (VCM) 23 is connected. The action of the VCM 23 rotates the carriage block 17 around the spindle 18. Such rotation of the carriage block 17 enables swinging movement of the carriage arm 19 and the head suspension 21. When the carriage arm 19 swings around the spindle 18 while the flying head slider 22 is flying, the flying head slider 22 can move along the radial line of the magnetic disk 14. As a result, the electromagnetic transducer device on the flying head slider 22 can traverse the data zone between the innermost recording track and the outermost recording track. Through such movement of the flying head slider 22, the electromagnetic transducer device can be positioned above a target recording track.

FIG. 2 schematically illustrates a structure of the magnetic disk 14 of the embodiment. On the front and back surfaces of the magnetic disk 14, a plurality of recording tracks 25 extend along the circumferential direction that is the down-track direction of the magnetic disk 14. The recording tracks 25 are concentrically formed. On the front and back surfaces of the magnetic disk 14, a plurality of (for example, sixty) servo regions 26 are defined that extend along the radial direction of the magnetic disk 14 while curving. The curve of the servo regions 26 is set based on a moving path of the electromagnetic transducer device. Between adjacent servo regions 26, a data region 27 is secured. In this manner, in each of the recording tracks 25, the servo region 26 and the data region 27 are alternately defined. The electromagnetic transducer device of the flying head slider 22 is positioned based on the magnetic pattern previously written in the servo regions 26.

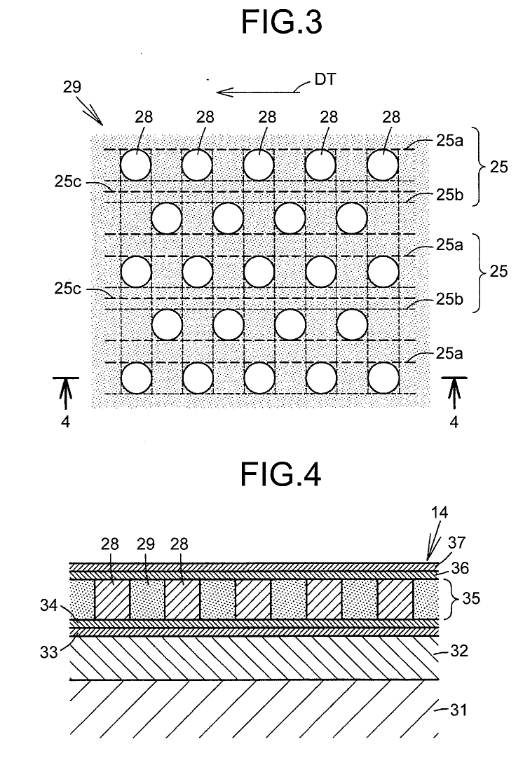

As illustrated in FIG. 3, each of the recording tracks 25 comprises two dot lines 25a and 25b. In each of the dot lines 25a and 25b, a plurality of magnetic dots 28 is arranged at regular intervals in the down-track direction DT. In each of the recording tracks 25, the dot line 25a is arranged on the inner side of the dot line 25b. Each of the magnetic dots 28 is formed by, for example, a magnetic pillar having a central axis perpendicular to a surface of the magnetic disk 14. The diameter of the magnetic dots 28 is set to, for example, about 20 nm. Each of the magnetic dots 28 is magnetized in upward (outward) or downward (inward) in the vertical direction perpendicular to the surface of the magnetic disk 14. Accordingly, magnetic information is recorded in each of the magnetic dots 28. In other words, a perpendicular magnetic recording is realized. The magnetic dots 28 are magnetically separated from each other by a nonmagnetic member 29. The magnetic dots 28 are arranged at least in the data regions 27.

In each of the dot lines 25a and 25b, the magnetic dots 28 are separated at spaces corresponding to the diameter of the magnetic dots 28. In each of the recording tracks 25, the magnetic dots 28 on the dot line 25b are shifted from the magnetic dots 28 on the dot line 25a in the down-track direction. On a radial line passing through the middle point of the center axes of an adjacent pair of the magnetic dots 28 on the dot line 25a, the central axis of each of the magnetic dots 28 on the dot line 25b is positioned. In other words, a staggered arrangement having a central line 25c of the recording tracks 25 as the center thereof is realized.

As illustrated in FIG. 4, the magnetic disk 14 comprises a substrate 31. The substrate 31 may be, for example, a glass substrate. On the surface of the substrate 31, a lining layer 32 spreads. The lining layer 32 may be made of soft magnetic material such as carbon-ion-tantalum (FeTaC) film and nickel-iron (NiFe) film. In the lining layer 32, the easy axis of magnetization is directed in the in-plane direction defined to be parallel to the surface of the substrate 31. On the surface of the lining layer 32, a tantalum (Ta) adhesion layer 33 spreads. The tantalum adhesion layer 33 has an amorphous structure. On the surface of the tantalum adhesion layer 33, a ruthenium (Ru) substrate layer 34 spreads. The ruthenium substrate layer 34 has a polycrystalline structure. Adjacent crystal grains closely contact.

On the surface of the ruthenium substrate layer 34, a recording layer 35 spreads. On the recording layer 35, the magnetic dots 28 and the nonmagnetic member 29 are formed. The magnetic dots 28 erect on the surface of the ruthenium substrate layer 34. The central axes of the pillar-shaped magnetic dots 28 are perpendicular to the surface of the substrate 31. In each of the magnetic dots 28, the easy axis of magnetization is directed to the vertical direction perpendicular to the surface of the substrate 31. The magnetic dots 28 are made of, for example, cobalt-chromium-platinum (CoCrPt). The magnetic dots 28 may be made of cobalt-platinum (CoPt). The surface of the recording layer 35 is coated with a protective film 36 such as a diamond-like carbon (DLC) film or a lubricating film 37 such as a perfluoropolyether (PFPE) film.

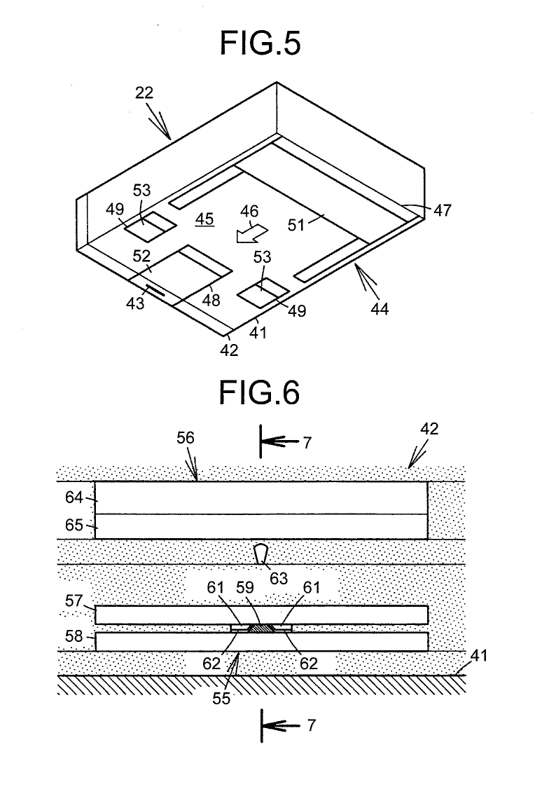

FIG. 5 illustrates one specific example of the flying head slider 22. The flying head slider 22 comprises, for example, a flat, rectangular parallelepiped slider main body 41. On the air outflow side end surface of the slider main body 41, a nonmagnetic film 42 is deposited. An electromagnetic transducer device 43 is embedded in the nonmagnetic film 42. The slider main body 41 may be made of hard nonmagnetic material such as Al₂O₃-Tic (AlTic). The nonmagnetic film 42 may be made of relatively soft insulating nonmagnetic material such as Al₂O₃ (Alumina).

The flying head slider 22 faces the magnetic disk 14 at a flying surface 44 as a medium facing surface. On the flying surface 44, a flat base surface 45 is provided as a reference surface. When the magnetic disk 14 rotates, an air flow 46 acts on the flying surface 44 from the front end to the back end of the slider main body 41.

On the flying surface 44, one front rail 47 is formed to stand from the base surface 45 on the upstream side of the air flow 46 or the air inflow side. Likewise, on the flying surface 44, a rear rail 48 and side rear rails 49 are formed to stand from the base surface 45 on the downstream side of the air flow or the air outflow side. The rear rail 48 extends from the slider main body 41 to the nonmagnetic film 42.

On the top surface of the front rail 47, the rear rail 48 and the side rear rails 49, air bearing surfaces (ABS) 51, 52, and 53 are defined. Air inflow ends of the ABSs 51, 52, and 53 are connected by steps to the top surfaces of the rails 47, 48, and 49. The air flow 46 generated by rotation of the magnetic disk 14 is received by the flying surface 44. At this time, relatively large positive pressure, i.e., buoyancy, is generated on the ABSs 51, 52, and 53 due to the steps. Besides, a large negative pressure is generated at the rear side, i.e., the back side, of the front rail 47. The flying attitude of the flying head slider 22 is determined based on the balance between the buoyancy and negative pressure. Note that the shape of the flying head slider 22 is not limited to this.

As illustrated in FIG. 6, the electromagnetic transducer device 43 comprises a reading element 55 and a writing element 56 as a magnetic recording head. The reading element 55 uses a tunnel junction magnetic resistance effect (TuMR) element. Specifically, the reading element 55 comprises a pair of upper and lower conductive layers that are an upper electrode 57 and a lower electrode 58. Between the upper electrode 57 and the lower electrode 58, a tunnel junction magnetic resistance effect film 59 is sandwiched. The upper electrode 57 and the lower electrode 58 may be made of high permeability material such as iron nitride (FeN), nickel-iron (NiFe), nickel-iron-boron (NiFeB), or cobalt-iron-boron (CoFeB). By using high permeability material, the upper electrode 57 and the lower electrode 58 can function as an upper shield layer and a lower shield layer. Consequently, the space between the upper electrode 57 and the lower electrode 58 defines magnetic recording resolution in the direction of the recording track lines on the magnetic disk 14.

Between the upper electrode 57 and the lower electrode 58, a pair of magnetic domain control films 61 is arranged. The tunnel junction magnetic resistance effect film 59 is arranged between the magnetic domain control films 61 along the flying surface 44. The magnetic domain control films 61 are made of hard magnetic material such as cobalt-chromium-platinum (CoCrPt) or cobalt-platinum (CoPt). The magnetic domain control films 61 realize magnetization in one direction along the flying surface 44. Between the magnetic domain control films 61 and the lower electrode 58 and between the magnetic domain control films 61 and the tunnel junction magnetic resistance effect film 59, insulating films 62 are sandwiched. The insulating films 62 are made of, for example, Al₂O₃ or magnesium oxide (MgO). The magnetic domain control films 61 are insulated from the lower electrode 58 and the tunnel junction magnetic resistance effect film 59. Therefore, even when the magnetic domain control films 61 are conductive, conductivity between the upper electrode 57 and the lower electrode 58 is provided only through the tunnel junction magnetic resistance effect film 59.

From the upper electrode 57 and the lower electrode 58 to the tunnel junction magnetic resistance effect film 59, a predetermined value of voltage is applied. A current amount, or a current value is detected. When a magnetic field acts from the magnetic disk 14 to the tunnel junction magnetic resistance effect film 59, resistance change of the tunnel junction magnetic resistance effect film 59 is caused in accordance with the direction of the magnetic field or an acting magnetic pole. This resistance change is converted to a change in current amount. Based on the change in current amount, information is read from the magnetic disk 14.

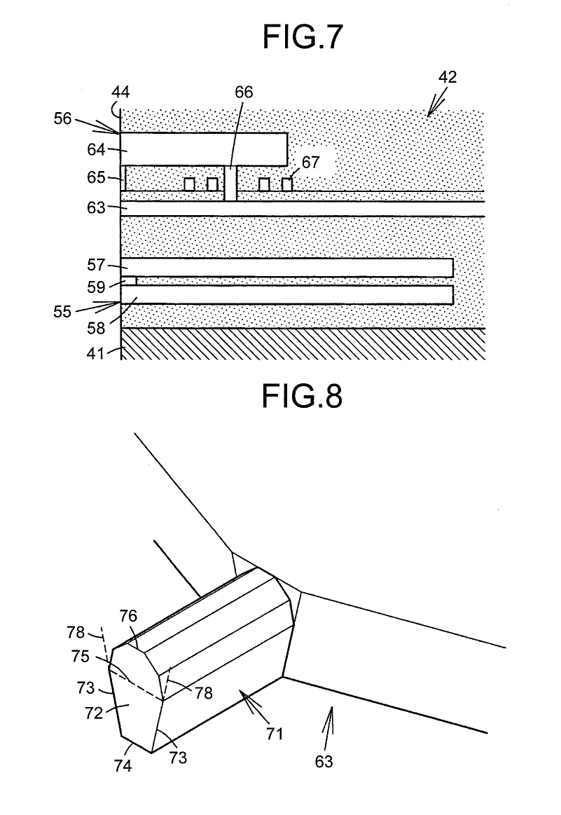

The writing element 56 uses a single magnetic pole head. Specifically, the writing element 56 comprises a main magnetic pole 63 and an auxiliary magnetic pole 64. End surfaces of the main magnetic pole 63 and the auxiliary magnetic pole 64 are exposed at the surface of the rear rail 48 that is the flying surface 44. At the leading end of the auxiliary magnetic pole 64 on the flying surface 44, a trailing shield 65 is defined. The trailing shield 65 faces the main magnetic pole 63. The main magnetic pole 63, the auxiliary magnetic pole 64 and the trailing shield 65 are made of magnetic material such as FeN, NiFe, NiFeB, or CoFeB. Alternatively, the main magnetic pole may be made of cobalt-iron (CoFe). The auxiliary magnetic pole 64 and the trailing shield 65 may be formed of cobalt-nickel-iron (CoNiFe). As illustrated in FIG. 7, a magnetic connecting piece 66 is arranged between the auxiliary magnetic pole 64 and the main magnetic pole 63 and at a position away from the flying surface 44. The magnetic connecting piece 66 connects the auxiliary magnetic pole 64 to the main magnetic pole 63. The main magnetic pole 63, the magnetic connecting piece 66, the auxiliary magnetic pole 64 and the trailing shield 65 form a magnetic core. Around the magnetic connecting piece 66, along a plane parallel to the surface of the main magnetic pole 63, a thin film coil pattern 67 is formed as a magnetic coil.

FIG. 8 schematically illustrates the end of the main magnetic pole 63 of the embodiment. The main magnetic pole 63 comprises a magnetic end piece 71. The magnetic end piece 71 extends backward from an end surface 72 with a uniform sectional shape. The end surface 72 is a flat surface. The end surface 72 is exposed on the flying surface 44. The end surface 72 corresponds to an exposed surface.

The contour of the end surface 72 is defined by oblique sides 73 and a lower side 74 of an inverted trapezoidal shape, and a contour line 76 extending from one end to the other end of an upper side 75 of the inverted trapezoidal shape. In the inverted trapezoidal shape, the lower side 74 on the leading side extends in parallel to the upper side 75 on the trailing side. The length of the upper side 75 is set larger than that of the lower side 74. Both ends of the upper side 75 and both ends of the lower side 74 are respectively connected by the oblique sides 73. The lengths of the two oblique sides 73 are set equal to each other.

The contour line 76 rises from the upper side 75 of the inverted trapezoidal shape toward the trailing side between extended lines 78 and 78 of the oblique sides 73. The contour line 76 is formed by a polygonal line. To form the rise, the corners of the contour line 76 are arranged along an arc of a semicircle having its center at the middle point of the upper side 75. One side of the polygonal line extends in parallel to the upper side of the inverted trapezoidal shape. The contour of the end surface 72 is bilaterally symmetric relative to the center line.

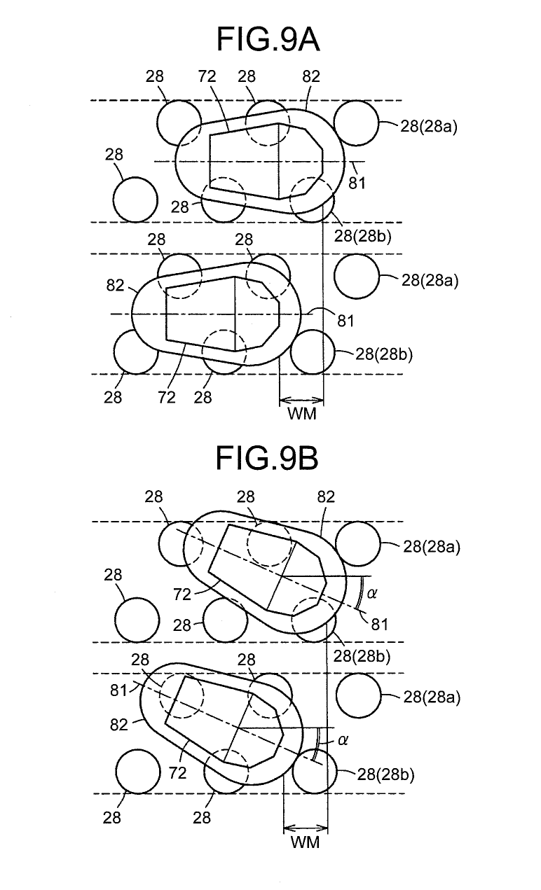

When electric current is supplied to the thin film coil pattern 67, magnetic flux is generated around the thin film coil pattern 67. The magnetic flux flows in the magnetic core. As illustrated in FIGS. 9A and 9B, the magnetic field leaks from the main magnetic pole 63. The leaked magnetic field acts on the magnetic dots 28. Consequently, magnetization is realized at each of the magnetic dots 28 in the vertical direction that is perpendicular to the surface of the magnetic disk 14. The direction of the magnetization is determined depending on the direction of the electric current.

When the writing element 56 is positioned to face the surface of the magnetic disk 14 at a center position of the magnetic disk 14 in the radial direction, for example, as illustrated in FIG. 9A, a center line 81 of the contour of the end surface 72 extends in parallel to the down-track direction. A yaw angle is set to “0” (zero) degree. In this case, when a magnetic field extension 82 overlaps the magnetic dot 28, even partially, the magnetic dot 28 is magnetized. If the direction of the electric current supplied to the thin film coil pattern 67 is switched while such overlap, magnetization of the magnetic dot 28 is inverted. Accordingly, in a condition where the magnetic field extension 82 contacts the magnetic dot 28, the end surface 72 approaches closest to the magnetic dot 28 when the magnetic dot 28 moves out of the area where the magnetic field extension 82 affects the magnetic dot 28. Between a position of the end surface 72, which is determined at the moment when a magnetic dot 28a moves away from the effect of the magnetic field extension 82 after the magnetization of the magnetic dots 28a, and a position of the end surface 72, which is determined at the moment when a subsequent magnetic dot 28b moves away from the effect of the magnetic field extension 82 after the magnetization of the magnetic dot 28b, is defined as a write margin WM.

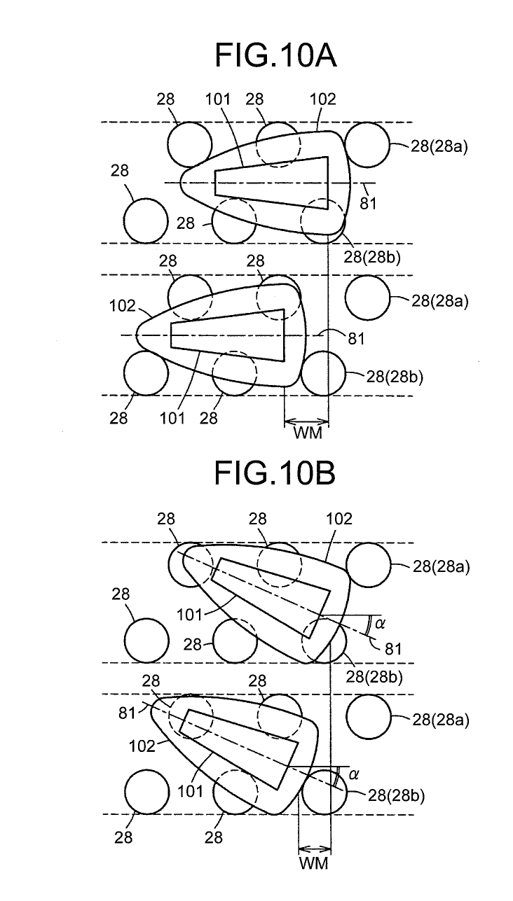

When the writing element 56 is positioned to face the outermost track of the magnetic disk 14, the contour of the end surface 72 inclines a predetermined angle α from the down-track direction, for example, as illustrated in FIG. 9B. A yaw angle (=α) is set. Also in this case, a sufficient write margin WM can be secured since the contour line 76 rises from the upper side 75 toward the trailing side between the extended lines of the oblique sides 73. With the contour line 76 of the end surface 72, the write margin WM can be effectively prevented from decreasing. The more the contour line 76 rises, the more the write margin WM is provided. It is desirable that the contour line 76 extend at least along the circular arc having its center at the middle point of the upper side 75. The contour line 76 may be inscribed of such a circular arc. With such configuration, the write margin WM can be kept constant independent of the increase of the yaw angle. On the other hand, when as illustrated in FIGS. 10A and 10B, for example, an end surface 101 of the main magnetic pole is formed in a simple inverted trapezoidal shape, a magnetic field extension 102 is defined to a corresponding shape. As the yaw angle increases, the write margin WM significantly decreases corresponding to corners of the upper side and the oblique sides.

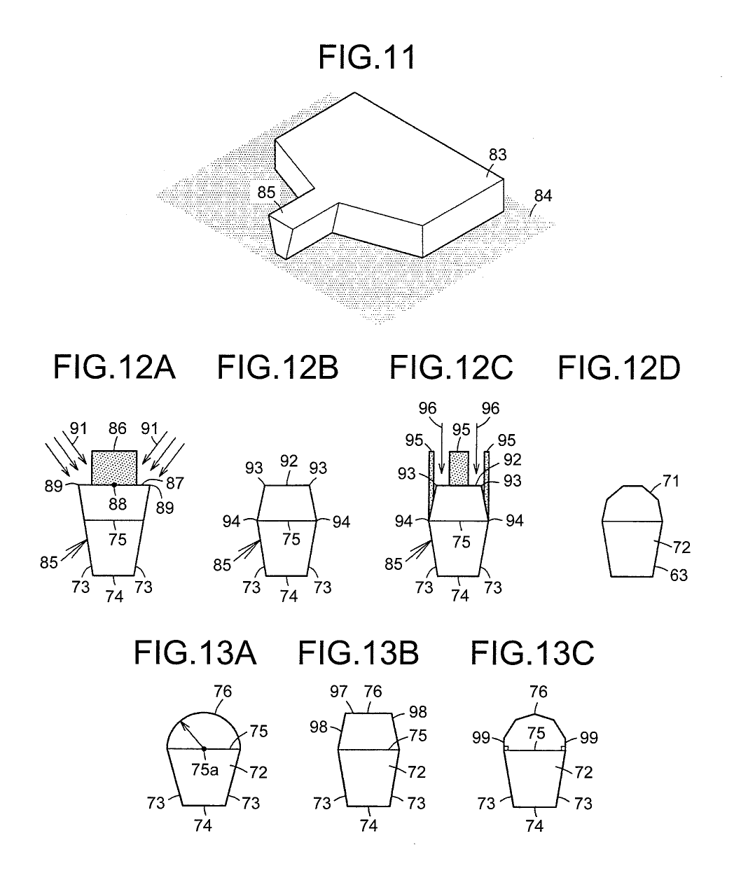

Next, a method of manufacturing the main magnetic pole 63 is briefly explained. First, as illustrated in FIG. 11, a main magnetic pole layer 83 is cut out. Upon cutting out, for example, on a nonmagnetic flat surface 84, a film without pattern made of a magnetic material is formed. On the surface of the film without pattern, a resist film is formed. The resist film forms the contour of the main magnetic pole 63. By removing the magnetic material around the resist film, the main magnetic pole layer 83 is formed. The magnetic material may be removed by, for example, etching. In a material piece 85 for the magnetic end piece 71, as has been known, a sectional shape of an inverted trapezoidal shape is realized corresponding to the ion irradiation angle.

Thereafter, as illustrated in FIG. 12A, a resist film 86 is formed on the material piece 85 for the magnetic end piece 71. The resist film 86 extends the entire length of the material piece 85 along the center line thereof. The center line is formed as an aggregate of middle points 88 of upper sides 87 of sectional shapes. A surface of the material piece 85 is exposed along the entire length of the material piece 85 between edge lines 89 formed as aggregates of both end points of the upper side 87 and the resist film 86. When ions 91 are irradiated at a predetermined inclination angle, as illustrated in FIG. 12B, the material piece 85 is chamfered along the entire length thereof. Through this chamfering, a connection of the inverted trapezoidal shape (the upper side 75, the lower side 74, and the oblique sides 73) as described above and a trapezoidal shape is defined as the sectional shape. The upper side 75 of the inverted trapezoidal shape corresponds to the lower side of the trapezoidal shape. In the trapezoid shape, an upper side 92 extends in parallel to the lower side 75. The length of the upper side 92 is set smaller than that of the lower side 75. Consequently, in the material piece 85, first edge lines 93 and second edge lines 94 are formed. The first edge lines 93 are formed as aggregates of both end points of the upper side 92 of the trapezoid shape. The second edge lines 94 are formed as aggregates of both end points of the lower side 75 of the trapezoid shape.

Then, as illustrated in FIG. 12C, a resist film 95 is additionally formed. The resist film 95 exposes the first edge lines 93 along the entire length of the material piece 85. When ions 96 are irradiated, as illustrated in FIG. 12D, the first edge lines 93 are scraped away. That is, chamfering is performed. Accordingly, the end surface 72 as described above is formed. The main magnetic pole 63 is formed. Through the formation of the magnetic end piece 71, the main magnetic pole layer 83 excepting the material piece 85 is kept coated with a resist film.

The shape of the end surface 72 is not limited to the shape as described above. For example, as illustrated in FIG. 13A, the contour line 76 may be a circular arc of a semicircle having its center at a middle point 75a of the upper side 75 of the inverted trapezoidal shape. Alternatively, for example, as illustrated in FIG. 13B, the contour line 76 may be an upper side 97 and oblique sides 98 of a trapezoidal shape. In this case, in the trapezoidal shape, the upper side 97 extends in parallel to the lower side 75. The lower side 75 of the trapezoidal shape corresponds to the upper side 75 of the inverted trapezoidal shape. In addition, as illustrated in FIG. 13C, the contour line 76 may be formed by a polygonal line comprising sides 99 standing perpendicularly from the both endpoints of the upper side 75 of the inverted trapezoidal shape.

As described above, according to the embodiment, more accurate write operation can be ensured.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic recording head comprising:
a flying surface; and
an exposed surface on the flying surface, wherein
the exposed surface comprising oblique sides and a lower side of a trapezoid comprising an upper side on trailing side, and a contour line,
wherein the lower side on a leading side extends in parallel to the upper side and is shorter than the upper side, and
the contour line extends from a first end to a second end of the upper side and expands from the upper side towards the trailing side between extended lines of the oblique sides.

2. The magnetic recording head of claim 1, wherein the contour line is a polygonal line.

3. The magnetic recording head of claim 1, wherein the contour line is a curving line.

4. The magnetic recording head of claim 3, wherein the contour line is an arc of a semicircle with a center at a middle point of the upper side.

5. A magnetic storage device comprising:
a housing;
a magnetic storage medium in the housing and comprising recording tracks in a staggered magnetic dot pattern; and
a magnetic recording head configured to face the magnetic storage medium, wherein
the magnetic recording head comprises a flying surface and an exposed surface on the flying surface,
the exposed surface comprising oblique sides and a lower side of a trapezoid comprising an upper side on trailing side, and a contour line,
wherein the lower side on a leading side extends in parallel to the upper side and is shorter than the upper side, and
the contour line extends from a first end to a second end of the upper side and expands from the upper side towards the trailing side between extended lines of the oblique sides.

6. The magnetic storage device of claim 5, wherein the contour line is a polygonal line.

7. The magnetic storage device of claim 5, wherein the contour line is a curving line.

8. The magnetic storage device of claim 7, wherein the contour line is an arc of a semicircle with a center at a middle point of the upper side.
